(19) United States
(12) Patent Application Publication
(10) Pub. No.: US 2018/0314227 A1
(43) Pub. Date: Nov. 1, 2018

(54) METHOD AND CONTROL APPARATUS FOR OPTIMIZED CONTROL OF A MACHINE TOOL

(71) Applicant: SIEMENS AKTIENGESELLSCHAFT, München (DE)

(72) Inventor: Jochen BRETSCHNEIDER, Esslingen (DE)

(73) Assignee: SIEMENS AKTIENGESELLSCHAFT, 80333 München (DE)

(21) Appl. No.: 15/763,976

(22) PCT Filed: Sep. 1, 2016
(86) PCT No.: PCT/EP2016/070564

§ 371 Date: Mar. 28, 2018

(30) Foreign Application Priority Data
Sep. 29, 2015 (EP) 15187409.6

(51) Int. Cl. G05B 19/31; G05B 19/4097; G05B 19/408

(52) U.S. Cl. CPC G05B 19/31; G05B 19/4097; G05B 2219/35159; G05B 2219/41174; G05B 2219/34276; G05B 19/4083

(57) ABSTRACT

A method and control apparatus for generating control data for controlling a tool on a machine tool for machining a clamped-in workpiece, the machine tool having a control apparatus and a tool for controlling the tool, comprising: generating a path program using a setpoint geometry of generated setpoint parameters, the path program describing a path having supporting points and line elements; controlling the machine tool according to the generated path program; detecting actual parameters by a feedback loop; iteratively optimizing the path program using the detected actual parameters for generating a new path program with a new path, the new path program being dynamically supplied in real time and the new path program dynamically changing and/or dynamically replacing the previous path program; providing CAM functionality for changing an order of the supporting points; and embodying both the path program and the new path program as a CNC program.

The invention relates to a method for generating control data for controlling a tool on a machine tool for processing a clamped-in workpiece by way of a processing process, in particular machining, wherein the machine tool comprises a control apparatus and a tool for controlling the tool in relation to the clamped-in workpiece with a three-dimensional free tool movement by generating a path program on the basis of a setpoint geometry of generated setpoint parameters for controlling the machine tool, wherein the path program describes at least one path, wherein the path consists of a plurality of supporting points and line elements and each line element connects a pair of the supporting points to one another, and the control of the machine tool is effected in accordance with the generated path program. The invention also relates to a further control apparatus.

In the following, a line element is to be understood as, for example, a straight line, a circle element or a higher-level geometric element (for example a spline) or a combination thereof.

During the processing of a workpiece (e.g. in tool making and die making) path programs based on CNC (computer numerical control) are as a rule used for controlling the machine in question, particularly if it is a milling machine. Nowadays, path programs (also called parts programs) are mainly generated by CAD/CAM/PP systems. The body or object to be produced is initially designed with a CAD (computer aided design) program and then transformed by a CAM (computer aided manufacturing) program into a machine-independent code (describes the processing process). A post-processor (PP) transforms the machine-independent code into a machine-dependent code, the so-called CNC-based path program, that can be used for controlling the particular concrete machine. The processing here is divided into various steps, e.g. rough machining, first-finishing and finishing.

In the finishing process, for example, the surfaces to be processed or produced are broken down into essentially equidistantly running path programs that describe the surface contour of the workpiece, which are then, for example in a machining process, milled by a milling machine. Such a path program is a path that consists of supporting points, pairs of which are connected by line elements (hereafter also called linear sets).

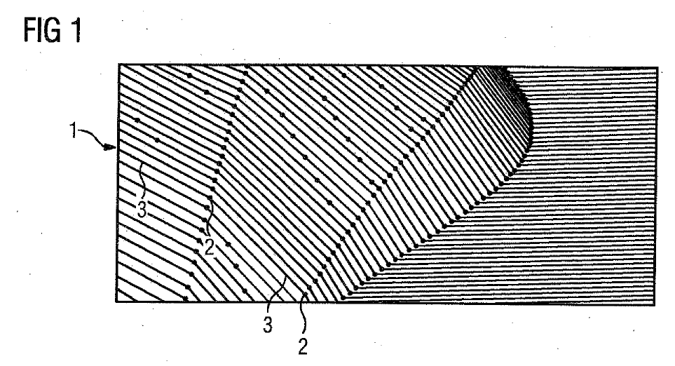

A section of such a program, or its graphical visualization, is reproduced in FIG. 1. Here, a surface contour is to be generated with numerous milling paths 1 running alongside one another (i.e. milling path sections approximately equidistant from one another). Each of the milling paths consists of a multiplicity of supporting points 2 and a multiplicity of linear sections 3. Between two adjacent supporting points 2 in each case is located a line element or a linear set that connects these two supporting points 2.

The path program that originated in the CAD/CAM/PP system is normally installed on a machine with an NC control unit and then run by a machine operator on the machine using the NC control unit. Here, the NC control unit treats each milling path section individually with a certain future time and distance horizon (look-ahead) and evaluates variations.

The path program, which may have been written in a CNC programming language, is created in advance and is not further modified at the time of processing by the CNC control unit. The processing technology, the tools, the technology parameters such as rotational speed of spindles, the machine functions, the path curve to be milled and the orientation and associated feed rate are defined in the path program in advance. As a rule, the values defined in the path program are not scrutinized by the CNC control unit. The path program itself is created before processing in a CAM system or other programming system and is then sent to the CNC control unit for processing.

This procedure does not permit autonomous modification of the path geometry or of the associated technology parameters at the time the CNC program is run by the CNC control unit, except through manual intervention by an operator. As a result, a potential optimum as regards minimal processing time, or full utilization of the tool and machining potentials such as tool life, machining performance or dynamics, is not achievable.

Moreover, the same processing problem is solved differently by different programmers and worked through differently on different machine types. Even in the case of identical machine characteristics, i.e. the same machine type, differing productivity as regards processing time, quality and costs is achieved in different production plants due to differing programming knowledge and strategies.

EP 2 216.698 A2 relates to a method and an apparatus for generating transformed control data for controlling a tool on a machine tool for processing a workpiece clamped into a clamping-in means of the machine tool by way of machining, with the process step of defining control data that specifies which first tool path, with which first tool orientation, is to be followed by the tool of the machine tool in order to process the clamped-in workpiece if the workpiece is clamped into the clamping-in means in accordance with a desired status of a clamping-in situation that represents a desired status of a clamping-in situation of the workpiece clamped into the clamping-in means, wherein the further process steps of determining an actual status of a clamping-in situation that represents an actual actual status of the clamping-in situation of the workpiece clamped into the clamping-in means, determining a variation in the clamping-in situation between the actual status of the clamping-in situation and the desired status of the clamping-in situation, which represents a variation between the actual status of the clamping-in situation and the desired status of the clamping-in situation, and generating transformed control data by undertaking a transformation of at least a part, depending on the determined variation in the clamping-in situation, of the defined control data, wherein the transformed control data indicates which second tool path, with which second tool orientation, is to be followed by the tool of the machine tool in order to process the clamped-in workpiece, with the determined variation of the clamping-in situation, if the workpiece is clamped into the clamping-in means in accordance with the actual status of the determined clamping-in situation.

The object of the invention is to provide a method and a control apparatus that have improved processing time and full utilization of tool and machine potentials in relation to the prior art.

The object in relation to the method is achieved by providing a method for generating control data for controlling a tool on a machine tool for processing a clamped-in workpiece by way of a processing process, in particular machining, wherein the machine tool comprises a control apparatus and a tool, for controlling the tool in relation to the clamped-in workpiece with a three-dimensional free tool movement by:
Generating a path program on the basis of a setpoint geometry of generated setpoint parameters for controlling the machine tool, wherein the path program describes at least one path, wherein the path consists of a plurality of supporting points and line elements and each line element connects a pair of the supporting points to one another,
Controlling the machine tool in accordance with the generated path program,
Detecting actual parameters of the processing process by a feedback loop, and
Iteratively optimizing the path program on the basis of detected actual parameters for generating a new path program_new with a new path_new, which are supplied during processing by the machine tool and which dynamically change and/or dynamically replace the previous path program and the previous path during processing.

The object in relation to the apparatus is achieved by providing a control apparatus for generating control data for controlling a tool on a machine tool for processing a clamped-in workpiece by way of a processing process, in particular machining, wherein the machine tool comprises a control apparatus and a tool for controlling the tool in relation to the clamped-in workpiece with a three-dimensional free tool movement by generating a path program on the basis of a setpoint geometry of generated setpoint parameters for controlling the machine tool, wherein the path program describes at least one path, wherein the path consists of a plurality of supporting points and line elements and each line element connects a pair of the supporting points to one another, and the subsequent control of the machine tool is provided in accordance with the generated path program, wherein a feedback loop for detecting actual parameters of the processing process is provided, and wherein iterative optimization of the path program is provided on the basis of the detected actual parameters for generating a new path program_new with a new path_new which are supplied during processing by the machine tool and which dynamically change or dynamically replace the previous path program and the previous path during processing.

According to the invention, iterative optimization of the path program on the basis of the detected actual parameters is now possible during the processing process due to the change in the technology parameters. It is possible here for the actual parameters also to comprise the status variables. The technology parameters for optimization can be divided into tool type, processing-relevant technology parameters and machine-related information. Examples of tool types are tool diameter and tool length, as well as, for example, number of cogs. Examples of processing-relevant technology parameters that can be used are cutting speed, feed rate/cog, lateral positioning and positioning in relation to depth. Examples of machine-related information are maximum permitted spindle output, maximum permitted spindle torque and maximum permitted axis dynamics, as well as maximum permitted feed rate. Technology parameters can also include the order of processing with different tools. Changing the technology parameters creates clearly established peripheral conditions for the generation of the new path program_new, which has a new path, or path and orientation.

The invention enables economically optimal utilization of the tool's potential and its machining features.

The present invention shows a way of dynamizing established procedure, i.e. working through an NC program generated in advance, with the aim of significantly reducing processing time and increasing cost-effectiveness. According to the invention, in order dynamically to influence technology parameters and thus also path and orientation during a processing process, a feedback loop from the processing process, for the measurement of actual parameters, is provided for the dynamic calculation of a new path.

The invention enables the same productivity to be achieved in identical machines and identical tools, irrespective of the programmer's know-how.

The dynamization of CNC processing according to the invention is achieved by exerting influence on more parameters than just the parameter “feed rate”.

According to the invention, integral optimization of processing is only possible if integral adaptation, both of technology parameters and the course of the path during the processing process is possible, i.e. in particular, deviation from, for example, a programmed path and orientation during runtime are permitted. Only in this way are optimal utilization of the tool's potential and its machining features possible.

The invention thus enables control-integrated dynamic optimization of processing by taking account of the specific machining features (“process analysis”) and technology possibilities.

Further advantages can be seen in reduced programming complexity and reduced processing time, or increased productivity, all charged tools being taken into account and, for example, automatic optimization of technology. The machine can also be programmed as a self-learning machine.

Further advantageous measures, which can be combined with one another as desired to achieve further advantages, are listed in the subclaims.

Preferably, at least one further iterative optimization of the generated path program_new and the path_new is possible. This means that the path program and the path itself can be continuously iteratively optimized.

Preferably, CAM functionality is provided for changing the order of the supporting points. It must be possible to execute the CAM function in real time, i.e. be able to react to identified optimization potential immediately and be able, during processing, to provide the CNC control unit with an optimized CNC program, or with an optimized path course.

In another preferred embodiment both the path program and the path program_new are embodied as a CNC program, with the CNC program of the path program_new changing and/or replacing the previous CNC program of the path program during processing. However, other machine languages are also possible.

Preferably, the path program_new contains a transitional strategy, in particular a transitional program with a transitional path. In this way an improved, dynamic transition from the old program to the new program can be achieved.

In an exemplary embodiment, iterative optimization of the path program is achieved in real time on the basis of the detected actual parameters for generating a new path program_new with a new path_new, which are dynamically supplied in real time during processing by the machine tool, and which change and/or replace the previous path program.

In an exemplary embodiment a database is provided that stores at least the path program and the path program_new. In a preferred embodiment, both the technology parameters/technology parameters_new and the detected actual parameters of the path program are also saved, as is the path program_new. In this way it is, possible to recycle the history and use it for subsequent workpieces.

As a result, empirical values can be generated that can be employed later for a self-learning machine or better, error-free processing.

Preferably, the path program_new can be supplied to the control apparatus either manually or automatically. This can be predefined by the programmer.

Further features, characteristics and advantages of the present invention can be found in the following description with reference to the attached schematic figures:

FIG. 1: is a pictorial representation of an NC path program in accordance with the prior art,

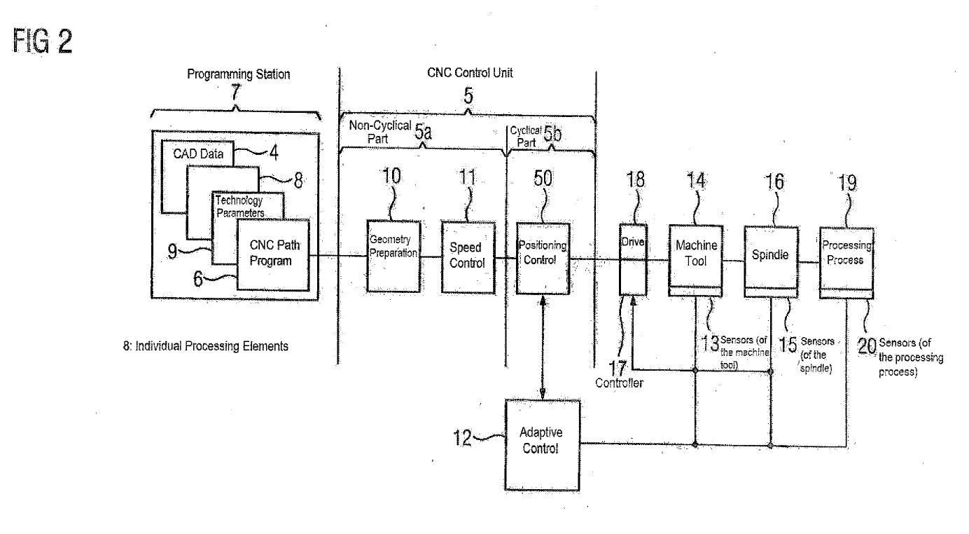

FIG. 2: shows a processing process of a workpiece by a tool in accordance with the prior art,

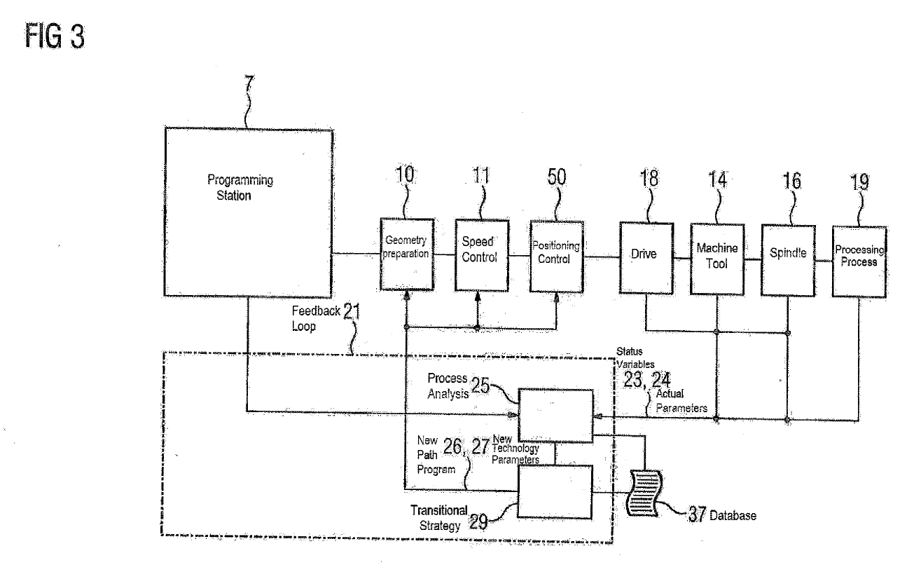

FIG. 3: shows dynamic program and path generation for CNC controlled machine tools according to the invention,

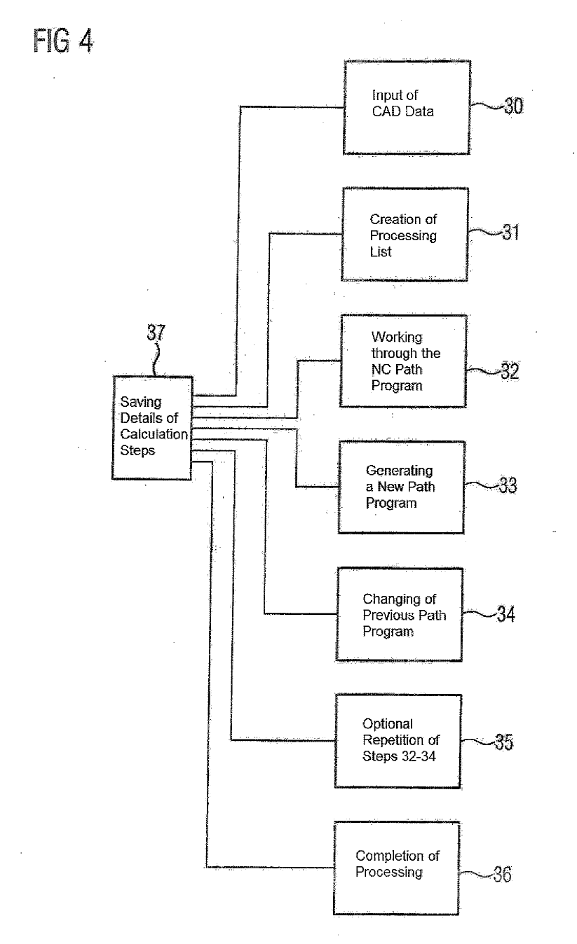

FIG. 4: is a schematic representation of an example of processing order according to the invention,

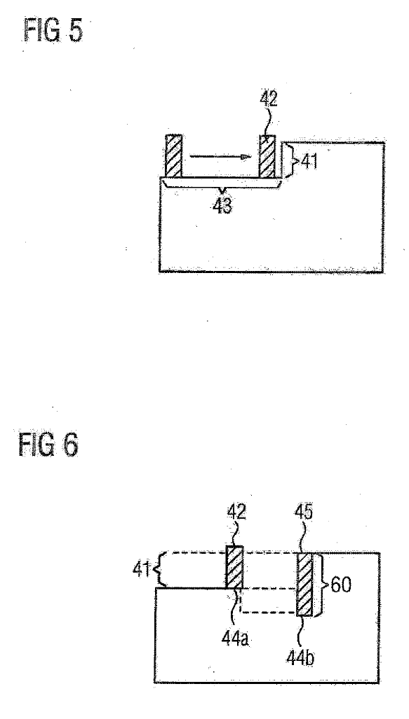

FIG. 5: shows, as a first example, rough machining (trimming) with a cutting depth predefined by the programmer in accordance with the prior art,

FIG. 6: shows the corresponding rough machining (trimming) with dynamically optimized cutting depth according to the invention,

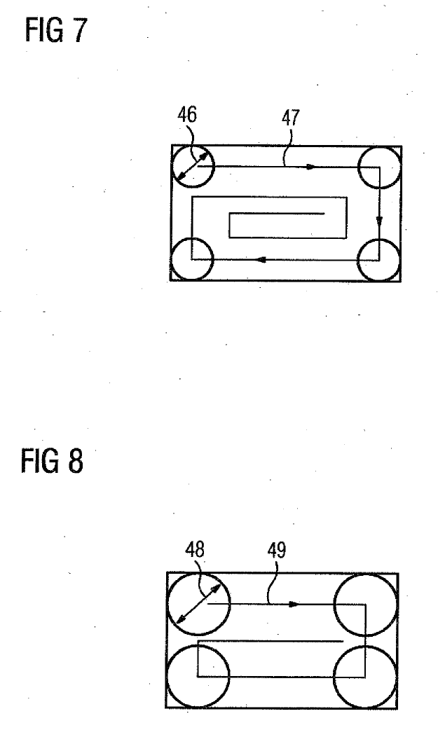

FIG. 7: shows, as a second example, face milling with a tool diameter predefined by the programmer in accordance with the prior art,

FIG. 8: shows the corresponding face milling with optimized tool diameter according to the invention,

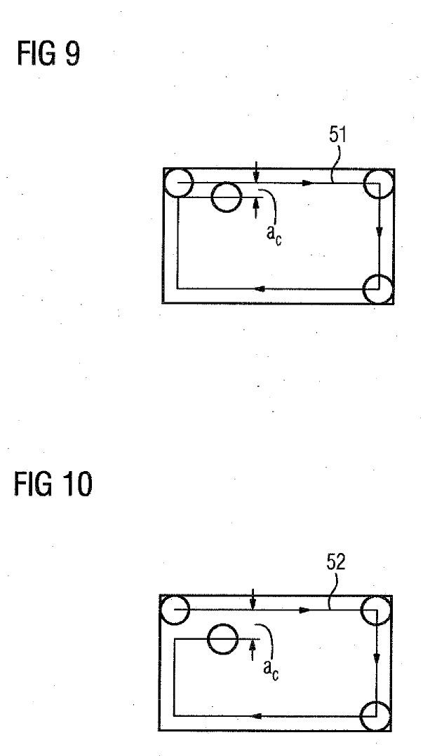

FIG. 9: shows, as a third example, face milling with lateral positioning predefined by the programmer in accordance with the prior art,

FIG. 10: shows the corresponding face milling with dynamically optimized lateral positioning according to the invention.

Although the invention has been illustrated and described in detail by the preferred exemplary embodiment, the invention is not limited by the disclosed examples. Those skilled in the art can derive variations from them without departing from the scope of protection of the invention as defined by the claims below.

FIG. 1 is a pictorial representation of a path program in accordance with the prior art and has already been described.

FIG. 2 is a schematic representation of a processing process of a workpiece by a tool in accordance with the prior art, i.e. the currently customary order in the CAD-CAM-CNC process chain. Nowadays CNC machine tools are controlled via the path program, for example in accordance with DIN 66025.

In such workpiece processing apparatus the positioning and movement of a tool employed in the processing of workpieces is controlled relative to a workpiece by means of a numerical control device (CNC control unit 5).

Here, the CNC path program 6 is created in advance at a programming station 7 and is not further modified by the CNC control unit 5 at the time of processing.

In addition, on the basis of CAD data 4, the processing is broken down by the programmer into individual processing elements 8 and the individual processing elements 8 are assigned, the technology parameters 9. The path program 6 is then created by the CAM system.

The programming station 7 can be embodied as part of the control unit 5.

It is also possible to define entire processing features such as, for example, pockets, via standardized interfaces. Here too, however, the CNC programs created are not further modified in the CNC control unit at the time of processing, except in a few exceptional cases. Modification of the data in the path program 6 is currently only known to a limited extent. The CNC control unit 5 is divided into a non cyclical part 5a and a cyclical part 5b. The non-cyclical part 5a comprises 10, geometry preparation, and 11, speed control, including look-ahead, as well as the generation of transformed control data by undertaking a transformation of control data depending on the determined variation in the clamping-in situation, or machine kinematics. The cyclical part 5b here primarily comprises interpolation and, if applicable, positioning control 50.

Modification of the technology parameters during runtime, both in the cyclical part 5b and the part 5a, is currently only known to a limited extent. This includes reduction of the programmed path speed, either as a result of the limited dynamic possibilities of the machine axes of the machine tool (reduction in speed) or by the operator, modification of the feed rate by adaptive control 12 depending on the spindle output, modification of the spindle speed in order to avoid chattering, by overlaying a wobble signal and a interfering signal, or permanent modification of the spindle speed.

In addition, in the prior art the technology parameter “feed rate” and the operating speed of the machine tool are calculated by sensors 13 in the case of the machine tool 14, sensors 15 in the case of the spindle 16 and by sensors 20 in the processing process 19, or in the controller 17 of the drive 18, and sent for process analysis, e.g. to the adaptive control 12. The adaptive control 12 can therefore only influence speed and feed rate. Also, it can only bring the technology parameters into the CNC control unit 5 cyclically. No further parameters are influenced.

To summarize, in the prior art, influence is therefore only exerted on two technology parameters, namely feed rate and speed. Once programmed, the pre-programmed path is not departed from. Extensive optimization in accordance with the present invention is therefore not possible. As a result, a potential optimum as regards minimal processing time and full utilization of the tool and machining potentials such as machining performance or dynamics, is not achievable.

In FIG. 3 the present invention shows a way of dynamizing this established procedure, with the aim of significantly reducing processing time and increasing productivity. The aim is to achieve the same productivity in identical machines and identical tools, irrespective of the programmer's know-how.

The dynamization of CNC processing according to the invention is achieved by exerting influence on more parameters than just the parameter “feed rate” or “speed”. According to the invention, it has been found that integral optimization of processing is only possible if integral adaptation, both of technology parameters and the course of the path during the processing process, is enabled, i.e. in particular, deviation from the programmed path and orientation during runtime are permitted. Only through deviation from the programmed path and orientation during runtime are optimal utilization of the tool's potential and its machining features possible.

Initially—as in the prior art—a target part described by CAD data 4 (FIG. 2) is broken down into processing elements 8 (FIG. 2) at a programming station 7 (FIG. 2) and assigned to this technology parameter, and in the CAM system 9 (FIG. 2) a CNC path program 6 is generated and sent to the CNC control unit 5. The actual parameters 24 are detected via the sensors 20, 15, 13 (FIG. 2) during the processing process 19, in the Spindle 16 and in the machine tool 14, as well as in the controller 17 (FIG. 2) in the drive 18. It is possible here for the actual parameters 24 also to comprise the status variables 23.

According to the invention, a feedback loop 21 is now provided that comprised of sensors 20, 15, 13 and the controller 17 for measuring status variables 23, and the actual parameters 24 for influencing the current path program 6 (FIG. 2) and for dynamically calculating a new path.

To this end, a process analysis 25 is then conducted in the feedback loop 21 and, as a result of this, a new path program_new 26 with corresponding updated technology parameters_new 27 is generated. The current path program 6 is then changed into and/or replaced by a path program_new 26 and a new optimized path_new and the current technology parameters 9 (FIG. 2) are changed into or replaced by new technology parameters_new. The new technology parameters_new 27 and the new path program_new 26 are then calculated with the aid of a CAM function that is executable in real time. It is also possible, in advance, to generate a transitional strategy 29, with a transitional program and transitional parameters, which then converts the old path program into the path program_new 26. In this way, a dynamic transition from the current path program 6 (“current” processing) (FIG. 2) to the new path program_new 26 (“new” processing) can be assured. The path program_new 26 and the new technology parameters_new 27 then become the current path program 6. These are replaced in the CNC control unit 5 (FIG. 2), both in the cyclical part 5a (FIG. 2) and in the non-cyclical part 5b (FIG. 2) in real time, i.e. during processing, and result in the measurement of new current status variables 23 and actual parameters 24. The CAM system that can be executed in real time can react immediately to identified optimization potential and during processing provide the CNC control unit 5 (FIG. 2) with an optimized CNC path program, or with an optimized path course. The details of the calculation steps and of the underlying data can be saved in a database 37.

The invention thus enables dynamic influencing of technology parameters, and hence of path and orientation, during a processing process.

The technology parameters for optimization can be divided into tool type, processing-relevant technology parameters and machine-related information. Examples of tool types are tool diameter and tool length, as well as, for example, number of cogs. Examples of processing-relevant technology parameters that can be used are cutting speed, feed rate/cog, and both lateral positioning and positioning of the tool in relation to depth. Examples of machine-related information are maximum possible spindle output, maximum possible spindle torque and maximum possible axis dynamics, as well as maximum possible feed rate.

The invention is schematically depicted below by way of the example of the following steps (FIG. 4):
Step 30: Input of CAD data of an unfinished part and the CAD data of the finished part (target part), as well as input of tolerance data and, where applicable, identification of features,
Step 31: Creation of a processing list with the aid of the input CAD data in the CAM system, in particular, creation of a path program. It should be noted here that in the first step it is not yet necessary for said creation to be automated. As a rule, the first step takes place during the process planning on the CAD-CAM system,
Step 32: Working through the NC path program and detecting status variables 23 and actual parameters 24 (FIG. 3), analyzing the status variables 23 and actual parameters 24 (FIG. 3), calculating alternative processing scenarios and evaluating and deciding whether optimization of processing is possible, in order to increase productivity. If the decision is in favor of optimized processing it can also include suggestions for the subsequent loading of tools,
Step 33: For optimized processing: generating a new path program_new 26 (FIG. 3) and a new path_new (FIG. 3), as well as a transitional strategy 29 (FIG. 3), with the aid of the new technology parameters_new 27 (FIG. 3),
Step 34: Automatic or, if applicable, manual changing of the old path program 6 (FIG. 2) and the old technology parameters 9 (FIG. 2) by dynamically loading the new path program_new 26 (FIG. 3), as well as a transitional strategy 29 (FIG. 3) and the new technology parameters_new 27, into the CNC control unit 5 (e.g. changing the machining strategy and thus changing the path program 6), e.g. possibility of manually replacing or subsequently loading tools by changing the path program 6/and thus changing the technology parameters during processing, including the transitional strategy 29 (FIG. 3), from the current path program 6/from current technology parameters 9 to the new path program_new 26/new technology parameters_new 27 or, for example, from old z positioning to new z positioning, is made possible by a new tool,
Step 37: Saving the details of the calculation steps and the underlying data in a database (FIG. 3),
Step 35: Optional repetition of the process from Step 32 onwards, in order to check for further optimization potential. Discontinuing optimization if no significant improvement is found,
Step 36: Completion of processing with the current path program and current technology parameters and saving in the database 37.

That means that both the new calculation and the subsequent new calculations of the path program, as well as of the technology parameters, are supplied to the CNC control unit in real time. The findings (materials, tool, operation, production strategy, technology parameters, etc.) are saved in a database 37.

FIG. 5, 6 show the prior art in comparison with the invention, by way of the example of the rough machining of an open pocket, with rough machining denoting the removal of material having a large chip volume. Rough machining in accordance with the prior art can be seen in FIG. 5. Here, the tool 42 always removes a hard programmed, unchangeable amount 41 from the material over a distance 43. FIG. 6 shows rough machining according to the invention. In this case, an amount 41 is also removed first. At point 44a, however, the optimization of this amount by means of the feedback loop 21 according to the invention (FIG. 3) begins. The changed path with the newly found amount 50 is supplied to the CNC control unit (FIG. 3) as path program_new 26, as a result of which the old NC path program, including a transitional path, which continues to the point 44b, is replaced dynamically. This results in reduced processing time. This can involve replacing the tool with, for example, a new tool 45.

FIG. 7, 8 show the prior art during stone milling processing in comparison with the invention, by way of the example of an exchangeable tool. FIG. 7 shows the processing in accordance with the prior art of a workpiece by a tool with the diameter 46. The diameter 46 has been predefined by the programmer and cannot be changed during the whole path 47. By contrast, FIG. 8 shows a tool, with a new diameter 48 and a newly calculated path 49, that has been changed by means of the feedback loop 21 (FIG. 3). The change of tool effected here results in a shorter processing time being achieved.

FIG. 9, 10 also show stone milling, in the comparison between a milling path 51 and a new milling path 52. In FIG. 9 the possibility of intervention, the feed rate, the cutting depth and the feed rate/cog have been predefined by the programmer, in accordance with the prior art. FIG. 10 shows the milling path dynamically influenced by means of the feedback loop 21 according to the invention (FIG. 3). Here, the superpositioning a_{c} of the tool (lateral positioning) has been optimized. As a result the cutting parameters have been changed.

1.-13. (canceled)

14. A method for generating control data for controlling a tool on a machine tool for processing a clamped-in workpiece by way of a processing process, in particular machining, wherein the machine tool comprises a control apparatus and a tool for controlling the tool in relation to the clamped-in workpiece with a three-dimensional free tool movement, said method comprising:
generating a path program on the basis of a setpoint geometry of generated setpoint parameters for controlling the machine tool, with the path program describing a path having a plurality of supporting points and line elements, with each line element connecting to one another supporting points of a pair of the supporting points;
controlling the machine tool in accordance with the generated path program;
detecting actual parameters of the processing process by a feedback loop;
iteratively optimizing the path program on the basis of the detected actual parameters for generating a new path program with a new path, with the new path program being dynamically supplied in real time during processing by the machine tool and the new path program dynamically changing and/or dynamically replacing the previous path program and the previous path during processing;
providing a CAM functionality for changing an order of the supporting points, with the CAM functionality capable of being run in real time;
embodying both the path program and the new path program as a CNC program, with the CNC program of the new path program changing and/or replacing a previous CNC program of the path program during processing; and
running the path program to process the clamped-in workpiece.

15. The method of claim 14, wherein following a control of the tool by the previous path program, the tool is first controlled by a transitional strategy.

16. The method of claim 14, wherein following, a control of the tool by the previous path program, the tool is first controlled by a transitional program with a transitional path, with the transitional program being generated in addition to the new path program.

17. The method of claim 14, wherein at least one further iterative optimization of the generated new path program is performed.

18. A control apparatus for generating control data for controlling a tool on a machine tool for processing a clamped-in workpiece by way of a processing process, in particular machining, wherein the machine tool comprises a control apparatus and a tool for controlling the tool in relation to the clamped-in workpiece with a three-dimensional free tool movement, the control apparatus configured to:
generate a path program on the basis of a setpoint geometry of generated setpoint parameters for controlling the machine tool, with the path program describing a path having a plurality of supporting points and line elements, with each line element connecting to one another supporting points of a pair of the supporting points;
control the machine tool in accordance with the generated path program;
detect actual parameters of the processing process by a feedback loop;
iteratively optimize the path program on the basis of the detected actual parameters for generating a new path program with a new path, with the new path program being dynamically supplied in real time during processing by the machine tool and the new path program dynamically changing and/or dynamically replacing the previous path program and the previous path during processing;
provide a CAM functionality for changing an order of the supporting points, with the CAM functionality capable of being run in real time;
embody both the path program and the new path program as a CNC program, with the CNC program of the new path program changing and/or replacing a previous CNC program of the path program during processing; and
run the path program to process the clamped-in workpiece.

19. The control apparatus of claim 18, further comprising at least one further iterative optimization of the generated new path program.

20. The control apparatus of claim 18, wherein a dynamic new technology parameter is selected from the group consisting of tool type, processing-relevant technology variables and machine-related information, and is dynamically changeable and/or dynamically replaceable during processing.

21. The control apparatus of claim 18, wherein the new path program contains a transitional strategy.

22. The control apparatus of claim 18, wherein the transitional strategy includes a transitional program with a transitional path.

23. The control apparatus of claim 18, wherein the iterative optimization of the path program is capable of being achieved in real time by the feedback loop at defined intervals of time, with the new path program being dynamically supplied at defined intervals of time during processing by the machine tool and changing or replacing the previous path program and the previous path.

24. The control apparatus of claim 18, further comprising a database configured to store at least the path program and the new path program.

25. The control apparatus of claim 25, wherein the database is configured to save technology parameters, new technology parameters, and the detected actual parameters of the path program.

26. The control apparatus of claim 18, wherein the new path program is supplied to the control apparatus manually or automatically.
